(19) United States
(12) Patent Application Publication
(10) Pub. No.: US 2013/0007900 A1
(43) Pub. Date: Jan. 3, 2013

(54) HIDING A CONTACT FIELD ON A WIRELESS HANDSET

(76) Inventor: Sreejith N. SANTHANU, Thrissur (IN)

(21) Appl. No.: 13/171,179

(22) Filed: Jun. 28, 2011

(51) Int. Cl. G06F 21/24

(52) U.S. Cl. 726/30

(57) ABSTRACT

A wireless handset configured to hide contact information fields associated with selected contacts is described. The wireless handset comprises a processor, a display, and a handset memory. The processor stores a list of contact entries on the handset memory. Each contact entry comprises a plurality of contact information fields. A user may select one or more of the contact entries to lock. The list is updated such that the contact information content of at least one contact information field is hidden when the locked contact entry is shown on the handset display. Additionally, a method for displaying contact entries on a wireless handset with one or more contact information fields hidden is described.

### FIELD

The present invention relates to displaying a contact list on a wireless handset. More particularly, the invention relates to hiding information from one or more contact information fields associated with one or more selected contacts in the contact list.

### BACKGROUND

It is desirable to protect the privacy of people whose contact information is stored in the address book on a wireless handset. If the handset owner loans the device to another, the contact information stored on the handset may be exposed. For example, the borrower may copy the phone number of a contact stored on the handset and use the information later to place an unwanted call to the contact.

However, storing a contact list on a wireless handset provides a convenient method to efficiently select the desired contact for a communication such as a phone call or SMS. It is thus desirable to view the identifying information stored in a contact list, such as a contact name, without revealing sensitive information pertaining to the contact, such as the contact's phone number. Further, it would be beneficial for the owner of the wireless handset to easily access the hidden contact information when needed.

### SUMMARY

A wireless handset configured to hide contact information fields associated with selected contacts is described. The wireless handset comprises a processor, a display, and a handset memory. The processor stores a list of contact entries on the handset memory. Each contact entry comprises a plurality of contact information fields. A user may select one or more of the contact entries to lock. The list is updated such that the contact information content of at least one contact information field is hidden when the locked contact entry is shown on the handset display.

The contact information fields of a contact entry may comprise identifying contact information, such as contact name, sensitive contact information and a contact phone number. When contact entries are locked, the contact entries may be displayed with the identifying contact information shown and the sensitive contact information hidden.

A software module may further be configured to allow the wireless handset user to view the content of the hidden contact information fields. The software module may prompt the user for a password to allow access to the hidden content. If the password is entered correctly, the hidden content is displayed.

In another embodiment, the wireless handset comprises a processor, a display, and a handset memory. The wireless handset further comprises a means for storing a list of contact entries on the handset memory, receiving input for locking at least one contact entry, and updating the list of contact entries such that the contact information content of at least one contact information field is hidden when the locked contact entry is shown on the display.

A method for displaying contact entries on a wireless handset is also described. The method comprises storing a list of contact entries in a handset memory, each contact entry comprising a plurality of contact information fields for storing contact information content. The method further comprises presenting the list of contact entries on a display, receiving input for locking one or more of the contact entries, and updating the list of contact entries such that the contact information content of at least one contact information field is hidden when the locked contact entry is shown on the display.

### DRAWINGS

The present invention will be more fully understood by reference to the following drawings which are for illustrative, not limiting, purposes.

FIG. 1 shows an illustrative wireless handset that permits hiding of one or more contact information fields.

FIG. 2 shows an illustrative communication system.

FIGS. 3A-3D show illustrative screen shots indicating how contact information field data is hidden within the address book application.

FIGS. 4A-4B shows illustrative screen shots showing prompting the user for a password to reveal the content of hidden contact information fields.

FIG. 5 shows an illustrative flowchart for hiding the content of contact information fields for selected contact entries.

FIG. 6 shows an illustrative flowchart for prompting the user for a password to reveal the content of hidden contact information fields.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the wireless handset, systems, and methods described hereinafter may vary as to configuration and as to details.

A wireless handset configured to hide the content of one or more contact information fields associated with selected contacts is described. An address book application runs on the wireless handset. The address book is a list of contact entries comprising a plurality of contact information fields. Contact information fields for a contact entry may include, for example, first name, last name, full name, home phone number, work phone number, mobile phone number, fax number, e-mail address and street address. Sensitive contact information fields are contact information fields that a user may wish to hide. For example, a phone number, fax number, or address may be a sensitive contact information field. In some embodiments, contact information fields containing identifying contact information, such as the first name, last name, or full name of the contact, may not be treated as sensitive contact information fields.

To prevent unauthorized viewing of sensitive contact information, the content of one or more contact information fields may be hidden for selected contacts. In one embodiment, a contact entry comprises identifying contact information, such as a contact name and sensitive contact information, such as a contact phone number. The wireless handset user may select contacts for which privacy is desired. For the selected contacts, the contact name is displayed and the contact phone number is hidden.

Leaving the identifying contact information unhidden allows the user to easily initiate a communication with the contact, for example, by choosing the contact name from the address book. The phone number or address required to initiate the communication is stored and associated with the contact entry in the handset memory. The handset can initiate the communication using the hidden sensitive information without displaying sensitive information on the handset display.

The contact phone number may be hidden from display not only within the address book, but throughout the wireless handset operations. For example, when an incoming call is received, the identifying contact information may be displayed on the handset display but the sensitive contact phone number remains hidden. Short message service (SMS) messages may be sent and received using only the identifying contact information while sensitive contact information remains hidden.

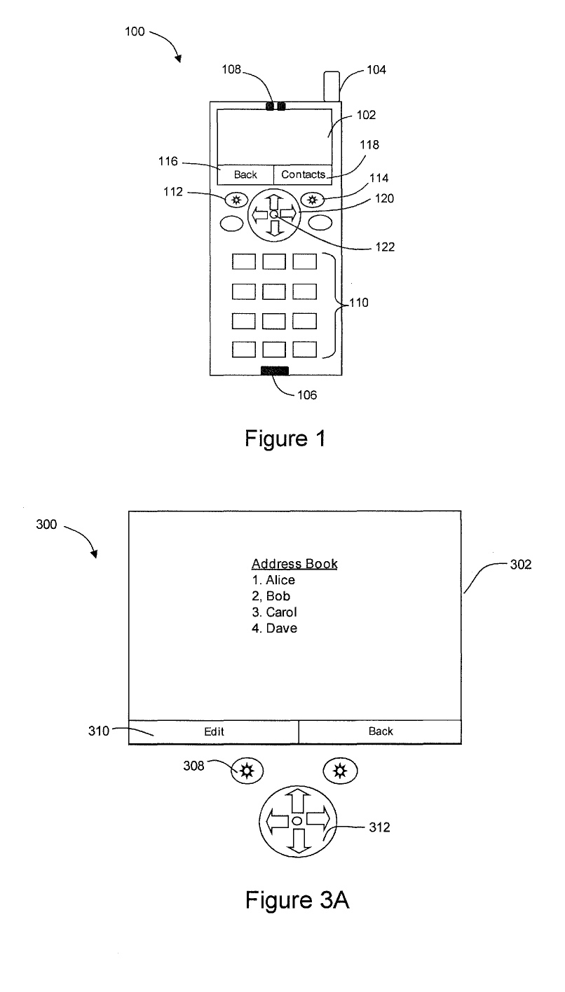

Referring to FIG. 1, an illustrative wireless handset 100 is shown. The wireless handset may a mobile handset, mobile phone, wireless phone, portable cell phone, cellular phone, portable phone, a personal digital assistant (PDA), or any type of mobile communications terminal capable of storing contact information for use in establishing contact with other communications devices. The wireless handset includes a display 102, an antenna 104, a microphone 106, and a speaker 108. The wireless handset may have a user input device that is a numeric keypad 110. Alternatively, the wireless handset may have a user input device that is an alphanumeric keypad (not shown) or a touchscreen input (not shown).

Wireless handset 100 may feature one or more soft keys, shown in FIG. 1 as 112 and 114. A soft key is a key which may be programmed to perform different functions in different contexts, rather than always being associated with a particular function. The soft key is typically adjacent to the display. The current functionality of the soft key is often indicated by text on the display positioned adjacent to the soft key. In FIG. 1, the functionality of soft keys 112 and 114 is indicated by the text shown in soft key text boxes 116 and 118, respectively. Thus, in the embodiment shown, pressing soft key 112 will activate the “Back” function, resulting in navigation back to the prior screen shown on the display, and pressing soft key 114 activates the “Contacts” function, which may allow the user to view contact entries in an address book.

A navigation key 120 may be included on the wireless handset. The navigation key features directional controls and may additionally include a selection control. The navigational key may include two-way directional controls (up and down, or left and right), four-way directional controls (up, down, left, and right), or more directional controls, such as an omnidirectional control. The navigational key can be a rocker-type control, issuing a direction control command when the key is depressed in one of the available directions. The selection control may be a separate button in the center of the navigation key, activated when the center button is pressed. Alternatively, the selection control may be integrated into the navigation key, activated when the navigation key is pressed inward (rather than in an available direction). Another navigational key embodiment is a roller-type control, moving a cursor on the display in any direction in which the control is rolled. The selection control of the roller-type control may be activated when the roller-type control is pressed inward. Alternatively, the selection control may be a separate button from the roller-type control.

In FIG. 1, the directional controls of rocker-type navigation key 120 are indicated by arrows, with the direction control issued when the navigation key is rocked in the direction of one of the arrows. Navigation key 120 also features a center button selection control 122. The navigation key may be used to select an item from the address book. In one exemplary embodiment, the address book is displayed as a list of contact entries, and the user presses the up and down directional controls of navigation key 120 until the desired contact entry is highlighted, then presses the center button to select the contact entry.

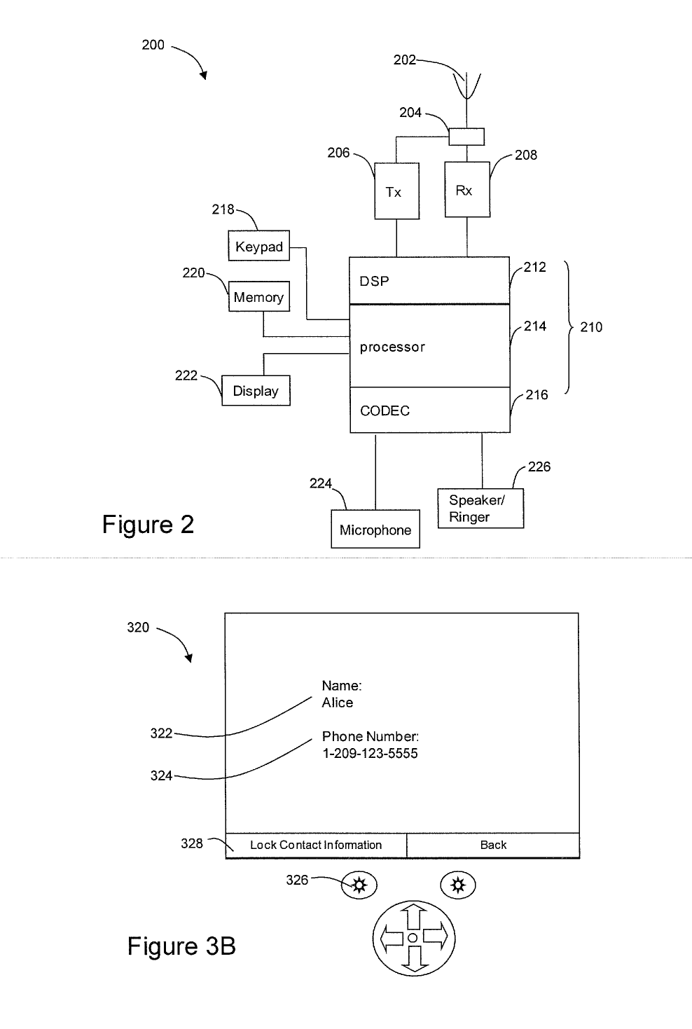

Referring to FIG. 2, there is shown a plurality of components associated with an illustrative wireless handset. The illustrative wireless handset 200 comprises a first antenna element 202 that is operatively coupled to a duplexer 204, which is operatively coupled to a transmitter module 206, and a receiver module 208.

An illustrative control module 210 comprises a digital signal processor (DSP) 212, a processor 214, and a CODEC 216 that are communicatively coupled to the transmitter 206 and receiver 208. It shall be appreciated by those of ordinary skill in the art that the transmitter module and receiver module are typically paired and may be embodied as a transceiver. The DSP 212 may be configured to perform a variety of operations such as controlling the antenna 202, the transmitter module 206, and the receiver module 208.

The processor 214 is operatively coupled to a keypad 218, memory 220, and display 222. Additionally, the processor 214 is also operatively coupled to a CODEC module 216 that performs the encoding and decoding operations and is communicatively coupled to microphone 224 and a speaker or ringer 226. The CODEC module 216 is also communicatively coupled to the display 222 and provides the encoding and decoding operations for video.

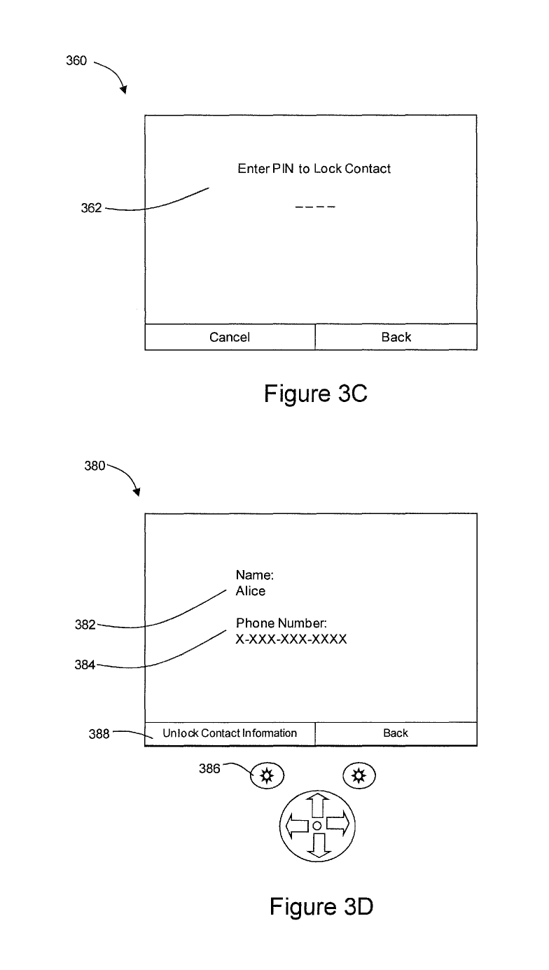

Referring to FIG. 3A, an illustrative screen shot 300 of an address book on wireless handset display 302 is shown. The address book shown is displaying contact entries for four contacts, Alice, Bob, Carol and Dave.

The user may scroll through the address book using navigation key 312. A contact entry may be highlighted to indicate that it is the active contact entry. For example, if the contact entry for Alice is currently highlighted, the user may tap the navigation key 308 in the direction of the down arrow to move down through the contact entries until the desired contact entry is highlighted.

In the embodiment shown, additional contact information fields associated with a selected contact may be accessed by pressing soft key 308 to select the Edit function shown at text box 310. Selecting the Edit function results in a display like that shown in FIG. 3B.

FIG. 3B shows an illustrative screen shot 320 of a contact entry page within the address book application. The contact entry for the contact Alice includes two contact information fields, a contact name field 322 and a contact phone number field 324. In the embodiment shown, the identifying contact information field is the contact name field 322 and the sensitive contact information field is contact phone number field 324. To hide the sensitive contact information field, the user may press soft key 326 to activate the Lock Contact Information function shown in text box 328.

In some embodiments, a user will be able to hide sensitive contact information fields for all contact entries simultaneously. For example, a Lock All Contacts function may be provided within the address book application.

After a user has input a request to hide the sensitive contact information field for one or more contact entries, the address book application prompts the user for a password.

FIG. 3C shows an illustrative screen shot 360 of an address book display prompting the user for a password after the user has input a request to hide sensitive contact information for a contact entry. The password may be, for example, a four digit numeric PIN. The password may have been entered into the device during user initialization of the device. In some embodiments, the same password is used for all security functions related to the handset. Alternatively, the password may be specific to address book security functions, such as hiding of the content of sensitive contact information fields. In this case, the password may be set for the first time when the user first seeks to hide sensitive contact information. The password may also have been set on the device by the manufacturer.

In one embodiment, a plurality of passwords may be used in conjunction with the address book application. The various passwords may be associated with varying levels of access to hidden contact information field content or access to various groups of contacts. For example, a super user password may provide access to all hidden contact information on the phone. A password for the group “Office” may only be accepted to reveal hidden contact information for contacts classified within the group “Office.”

If the user enters a password that matches the stored password, the sensitive contact information for the contact entry is hidden.

FIG. 3D shows an illustrative screen shot 380 of a contact entry page within the address book application after sensitive contact information has been hidden. In the embodiment shown, identifying contact information 382 is displayed, while the sensitive phone number field 384 is hidden, as indicated by the Xs replacing the digits of the phone number.

If a user wishes to reveal the hidden contact information, the user can request to unlock the contact information. In the illustrative embodiment, the user can press soft key 386 to activate the Unlock Contact Information function as indicated in text box 388. To ensure that only an authorized user may access the hidden sensitive contact information, the user is prompted for a password to unlock the hidden information.

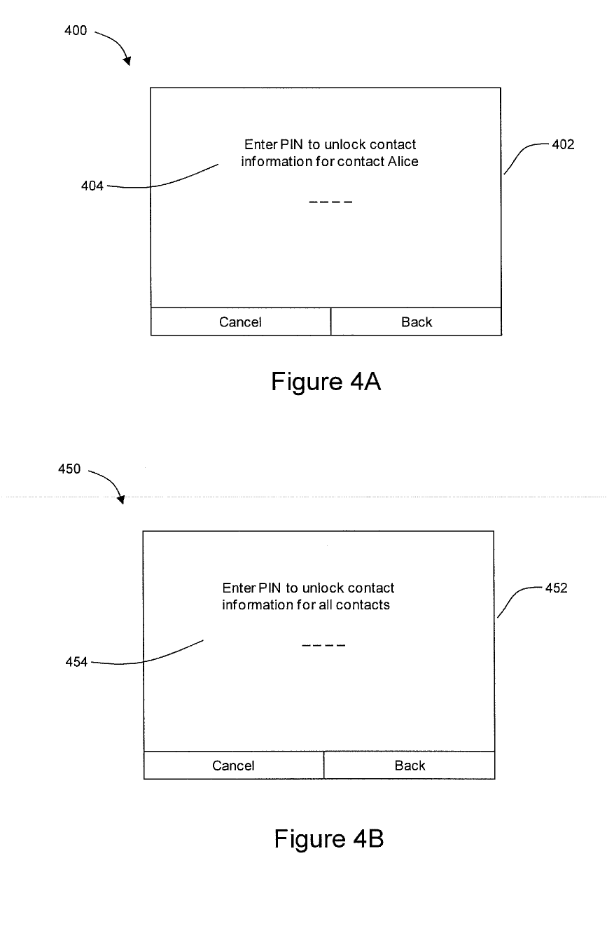

FIG. 4A shows an illustrative screen shot 400 of a display 402 presenting a password prompt to access sensitive contact information associated with a contact entry. In the embodiment shown in FIG. 4A, the user is prompted to enter a four digit PIN to reveal the phone number associated with the contact entry for Alice. Although the user wishes to protect the sensitive contact information associated with a contact, the user may need to access the sensitive information temporarily or periodically. The user may also wish to change the contact entry such that the sensitive contact information will no longer be hidden. Associating a password with the hiding function allows the user to access the hidden information when it is needed.

In some embodiments, the user will be able to unlock hidden contact information for all contact entries simultaneously. FIG. 4B shows an illustrative screen shot 450 of a display 452 presenting a password prompt 454 to allow the user to access sensitive contact information associated with all contact entries in an address book. In user enters the correct password, the content of all hidden contact information fields is revealed.

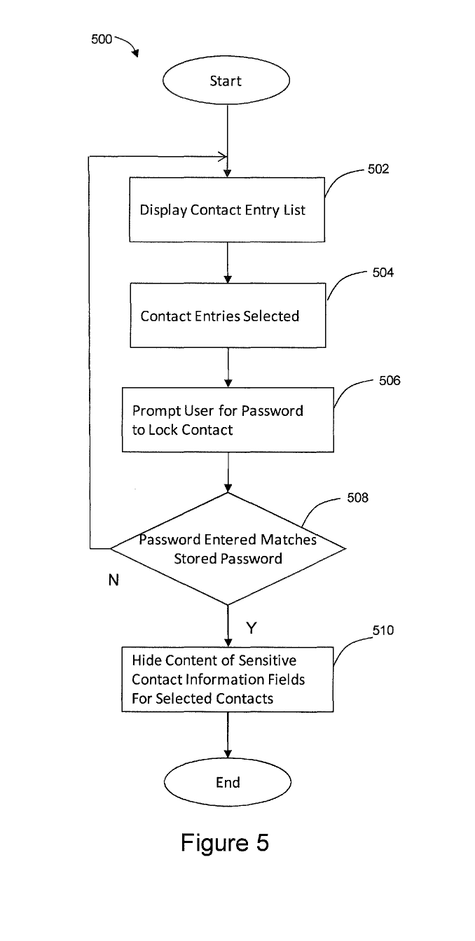

Referring to FIG. 5, there is shown an illustrative flowchart 500 of the process for hiding the content of contact information fields for selected contact entries. The method begins at block 502 where the list of contact entries is displayed as shown in FIG. 3A. At block 504, contact entries having sensitive contact information are selected, as demonstrated in the illustrative screen shot shown in FIG. 3B. At block 506, the user is prompted for a password to lock the sensitive contact information, as demonstrated in the illustrative screen shot shown in FIG. 3C. At decision diamond 508, if a password is entered by the user that matches the password stored in memory, the method proceeds to block 510. At block 510, the content of sensitive contact information fields is hidden for the selected contacts, as demonstrated in the illustrative screen shot shown in FIG. 3D.

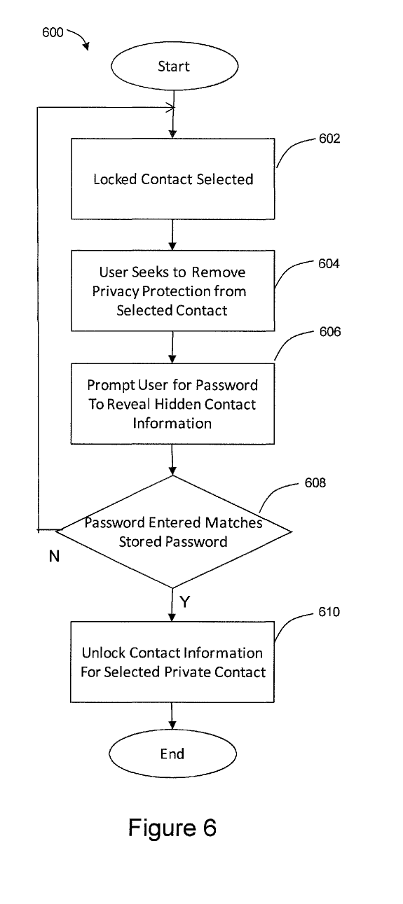

Referring to FIG. 6, there is shown an illustrative flowchart 600 for prompting the user for a password to reveal the content of hidden contact information fields. The method begins at block 602 where a contact with hidden contact information field data is selected. At block 604, the user seeks to remove privacy protection from the selected contact to reveal the content of the hidden contact information fields. For example, a user may try to uncheck a checkbox associated with a contact entry in the user interface shown in FIG. 3B in order to remove the privacy protection from the contact's sensitive contact information. At block 606, the user is prompted to enter a password to reveal the hidden contact information for the selected contact. For example, the password prompt shown in FIG. 4A may be displayed to the user. If at decision diamond 606, the user enters a password that matches the password stored in the handset memory, the hidden contact information field contact is revealed at block 610. However, if no password is entered that matches the stored password, the sensitive contact information remains hidden.

A wireless handset configured to hide the sensitive contact information associated with one or more contacts in an address book has been described. Identifying contact information, such as the contact name, remains unhidden to allow the user to efficiently look up the contact and utilize the contact information across the various functions provided by the handset.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A wireless handset, comprising:
a processor to support a plurality of functions to be performed by the handset;
a display operatively coupled to the processor;
a handset memory operatively coupled to the processor;
the processor configured to store a list of contact entries on the handset memory, each contact entry comprising a plurality of contact information fields for storing contact information content;
the processor configured to receive and input for locking of at least one contact entry; and
the processor configured to update the list of contact entries such that the contact information content of at least one contact information field is hidden when the locked contact entry is shown on the display.

2. The wireless handset of claim 1, wherein the contact information fields of a contact entry comprise a contact name and at least one contact phone number.

3. The wireless handset of claim 2, wherein the locked contact entries are presented with a contact name displayed and at least one contact phone number hidden.

4. The wireless handset of claim 1, wherein the processor is further configured to allow simultaneous locking of all contact entries in the list of contact entries.

5. The wireless handset of claim 1, wherein the processor is further configured to display a prompt for a password; wherein the contact information content stored in the hidden content fields associated with a selected contact entry is displayed when a password entered matches a stored password.

6. The wireless handset of claim 1, wherein the processor is further configured to display a prompt for a password; wherein the contact information content stored in the hidden content fields associated with all contact entries is displayed when a password is entered.

7. A wireless handset, comprising:
a processor to support a plurality of functions to be performed by the handset;
a display operatively coupled to the processor;
a handset memory operatively coupled to the processor;
a means for storing a list of contact entries on the handset memory, each contact entry comprising a plurality of contact information fields for storing contact information content;
a means for receiving an input for locking of at least one contact entry; and
the processor configured to update the list of contact entries such that the contact information content of at least one contact information field is hidden when the locked contact entry is shown on the display.

8. The wireless handset of claim 7, wherein the contact information fields of a contact entry comprise a contact name and at least one contact phone number.

9. The wireless handset of claim 8, wherein the locked contact entries are presented with a contact name displayed and at least one contact phone number hidden.

10. The wireless handset of claim 7, wherein the means for receiving input for locking of contact entries is configured to allow simultaneous locking of all contact entries in the list of contact entries.

11. The wireless handset of claim 7, further comprising means for prompting for a password; wherein the contact information content stored in the hidden content fields associated with a selected contact entry is displayed when the password is entered.

12. The wireless handset of claim 7, further comprising means for prompting for a password; wherein the contact information content stored in the hidden content fields associated with all contact entries is displayed when a password is entered.

13. A method for displaying contact entries on a wireless handset, the method comprising:
storing a list of contact entries in a handset memory, each contact entry comprising a plurality of contact information fields for storing contact information content;
presenting the list of contact entries on a display;
receiving an input for locking of one or more of the contact entries; and
updating the list of contact entries such that the contact information content of at least one contact information field is hidden when the locked contact entry is shown on the display.

14. The method of claim 13, further comprising:
receiving input for simultaneous locking of all contact entries;
displaying all contact entries with one or more contact information fields hidden.

15. A method of claim 13, further comprising:
displaying a prompt for a password;
displaying the contact information content stored in hidden content fields associated with the selected contact entry when the password is entered.

16. The wireless handset of claim 13, further comprising:
displaying a prompt for a password;
displaying the contact information content stored in hidden content fields associated with the all contact entries when the password is entered.
